(19) United States
(12) Patent Application Publication
(10) Pub. No.: US 2008/0119316 A1
(43) Pub. Date: May 22, 2008

(54) APPARATUS FOR EXPANDING GEAR SPEED RATIO COVERAGE OF AN AUTOMATIC TRANSMISSION

(76) Inventor: James P. Ordo, Avon, IN (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/561,025

(22) Filed: Nov. 17, 2006

(51) Int. Cl. F16H 47/08

(52) U.S. Cl. 475/59

(57) ABSTRACT

The present invention provides an apparatus configured to selectively increase the gear speed ratio coverage of an automatic transmission. The apparatus includes a torque converter operatively connected to and driven by an engine. A planetary gearset is operatively connected to the torque converter and the automatic transmission. Output from the torque converter is transferable through the planetary gearset to the automatic transmission such that additional speed ratios are obtainable. A clutch is disposed between the engine and the automatic transmission. The clutch is configured to selectively couple the engine and the automatic transmission such that the planetary gearset and the torque converter are bypassed.

### TECHNICAL FIELD

The present invention pertains generally to an apparatus configured to selectively increase the gear speed ratio coverage of an automatic transmission.

### BACKGROUND OF THE INVENTION

Generally, a motor vehicle automatic transmission includes a number of gear elements coupling its input and output shafts, and a related number of torque establishing devices such as clutches and brakes that are selectively engageable to activate certain gear elements for establishing a desired speed ratio between the input and output shafts. The transmission input shaft is connected to the vehicle engine through a damper or a fluid coupling such as a torque converter, and the output shaft is connected directly to the vehicle wheels.

The transmission speed ratio is defined as the transmission input speed divided by the transmission output speed. Thus, a low gear range has a high speed ratio and a higher gear range has a lower speed ratio. The number of obtainable speed ratios is generally dependent on the type of transmission. For example, a five speed transmission provides five forward speed ratios, and a six speed transmission provides six forward speed ratios. For some applications, it may be advantageous to provide additional speed ratios (i.e., expanded ratio coverage) in order to optimize vehicle performance and improve fuel economy.

### SUMMARY OF THE INVENTION

The apparatus of the present invention is configured to expand the gear ratio coverage of an automatic transmission. The apparatus includes a torque converter operatively connected to and driven by an engine. A planetary gearset is operatively connected to the torque converter and the automatic transmission. Output from the torque converter is transferable through the planetary gearset to the automatic transmission such that additional speed ratios are obtainable. A clutch is disposed between the engine and the automatic transmission. The clutch is configured to selectively couple the engine and the automatic transmission such that the planetary gearset and the torque converter are bypassed.

The apparatus may include a damper assembly disposed between the clutch and the automatic transmission, wherein the damper assembly is configured to at least partially absorb any engine torque spikes before they are transferred to the automatic transmission and thereby provide smoother operation.

The torque converter may include a pump operatively connected to the engine; a turbine operatively connected to the planetary gearset; and a stator disposed between the pump and the turbine.

The apparatus may include a one-way clutch assembly operatively connected to the stator and to the planetary gearset.

The planetary gearset may include a sun gear member operatively connected to the one-way clutch assembly; a ring gear member operatively connected to the turbine; and a pinion gear member operatively connected to the transmission.

The apparatus may include a ground sleeve operatively connected to the one-way clutch assembly such that at least a portion of the one-way clutch is grounded.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration of a vehicle in accordance with the present invention; and

FIG. 2 is a schematic sectional view of a torque converter and a planetary gearset in accordance with the present invention.

### DESCRIPTION OF THE PREFERRED EMBODIMENTS

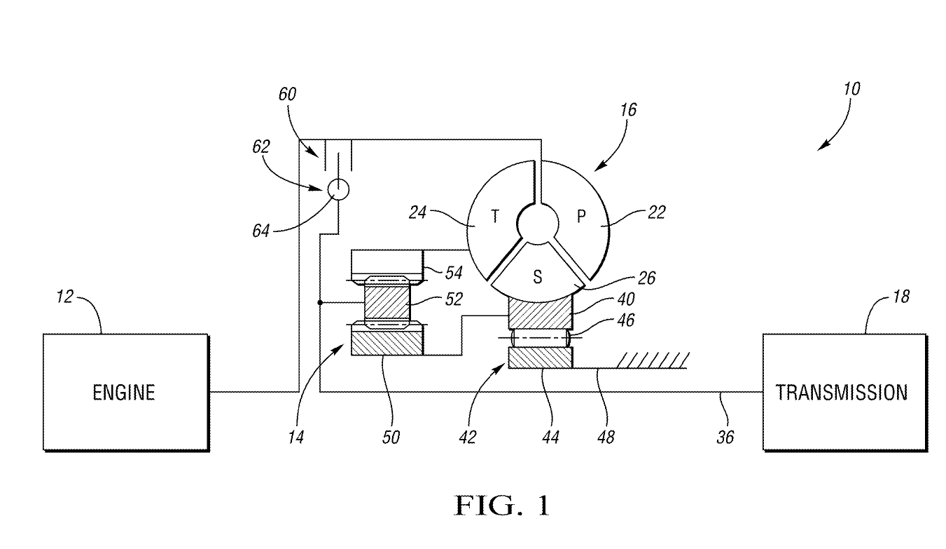

Referring to the drawings, wherein like reference numbers refer to like components, FIG. 1 shows a schematic representation of a vehicle 10 in accordance with the present invention. The vehicle 10 includes an engine 12, a planetary gearset 14, a torque converter 16, and a transmission 18. According to the preferred embodiment, the transmission 18 is a six speed transmission configured to selectively produce the following speed ratios: 3.52, 1.88, 1.40, 1.00, 0.76 and 0.64. It should be appreciated, however, that the present invention is also applicable to other transmissions. For purposes of the present invention, the speed ratio of the transmission 18 is defined as the transmission input speed divided by the transmission output speed. Similarly, the speed ratio of the planetary gearset 14 is defined as the planetary input speed divided by the planetary output speed, and the speed ratio of the torque converter 16 is defined as the torque converter input speed (or pump speed) divided by the torque converter output speed (or turbine speed).

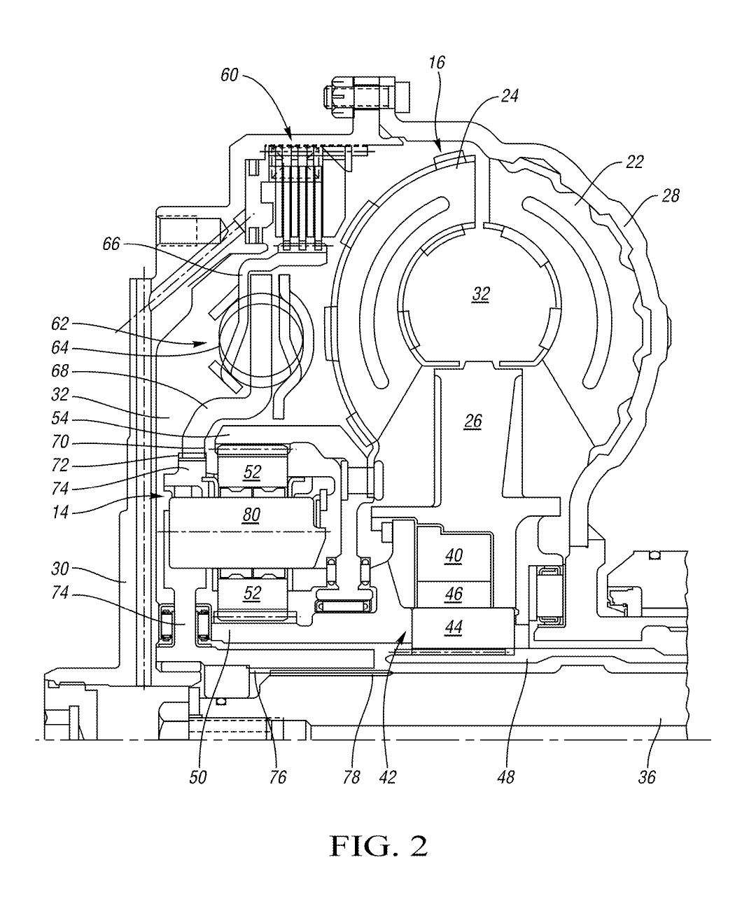

The torque converter 16 includes a pump 22, a turbine 24, and a stator 26. The engine 12 and the transmission 18 are respectively disposed at opposing sides of the torque converter 16. As shown in FIG. 2, the torque converter 16 further includes a housing 28 attached to a torque converter cover 30 such that a chamber 32 full of working fluid (not shown) is formed therein. The housing 28 is fixed to the pump 22 so that the housing 28 and pump 22 rotate together.

Referring again to FIG. 1, the pump 22 is driven by the engine 12 as will be described in detail hereinafter. As is known in the art, engine torque is transmittable from the pump 22 to the turbine 24 through an operation of the working fluid (not shown). The turbine 24 is connected to the planetary gearset 14, and the planetary gearset 14 is connected to an input shaft 36 of the transmission 18 such that engine torque is ultimately transferable to the transmission 18.

Rotation of the pump 22 causes working fluid (not shown) to be directed outward toward the turbine 24. When this occurs with sufficient force to overcome the resistance to rotation, the turbine 24 begins to rotate or turn. This turbine rotation may be implemented to drive the transmission input shaft 36 and thereby power the vehicle 10. The fluid flow exiting the turbine 24 is directed back into the pump 22 by way of the stator 26. The stator 26 redirects the fluid flow from the turbine 24 to the pump 22 in the same direction as the pump rotation, thereby reducing pump torque and causing torque multiplication.

The stator 26 is mounted to the outer race 40 of a one-way clutch assembly 42 such that the stator 26 and the outer race 40 rotate together. According to a preferred embodiment, the one-way clutch assembly 42 is a roller clutch, however, alternate one-way clutch configurations may be envisioned. The preferred one-way clutch assembly 42 includes the outer race 40, an inner race 44 and a roller 46 disposed therebetween. The inner race 44 is secured to a ground sleeve 48 such that the inner race 44 is grounded. The rotation of the outer race 40 relative to the inner race 44 is facilitated by the roller 46 in a first direction, and is prevented in an opposite direction by a conventional locking mechanism (not shown). The outer race 40 is connected to the planetary gearset 14 as will be described in detail hereinafter.

The planetary gearset 14 is inserted into the mechanical path between the turbine 24 of the torque converter 16 and the transmission input shaft 40. The planetary gearset 14 includes a sun gear 50, a pinion gear 52 and a ring gear 54. The sun gear 50 is operatively connected to the outer race 40 such that the sun gear 50, the outer race 40 and the stator 26 rotate together. The ring gear 54 is operatively connected to the turbine 24 such that the ring gear 54 and the turbine 24 rotate together. The pinion gear 52 is operatively connected to the transmission input shaft 36 such that the rotation of the pinion gear 52 is transferable to the transmission 18. The pinion gear 52 and the transmission input shaft 36 are also operatively connected to a clutch 60 via a damper assembly 62 as will be described in detail hereinafter.

The clutch 60 is selectively engageable to bypass the planetary gearset 14 so that the torque converter speed ratio becomes 1. In other words, when the clutch 60 is engaged, engine torque is transferred through the clutch 60, through the damper assembly 62 and to the transmission input shaft 36 without any torque multiplication from the planetary gearset 14 or the torque converter 16.

The damper assembly 62 is disposed between the clutch 60 and the transmission input shaft 36, and includes one or more damper springs 64 that are each secured between a driving member 66 (shown in FIG. 2) and a driven member 68 (shown in FIG. 2). When the clutch 60 is engaged, engine torque is transferred from a flywheel (not shown) to the cover 30 (shown in FIG. 2), through the clutch 60 and to the driving member 66. The rotation of the driving member 66 initially compresses the damper springs 64 between the driving and driven members 66, 68, and thereafter the compressed damper springs 64 transfer the rotation of the driving member 66 to the driven member 68. Accordingly, the damper springs 64 are adapted to at least partially absorb engine torque spikes before they are transferred to the transmission 18 and thereby provide smoother vehicle operation.

Torque is transferable from the engine 12 (shown in FIG. 1) to the transmission 18 (shown in FIG. 1) through one of two power flow paths. The first power flow path is selectable by engaging the clutch 60, and the second power flow path is selectable by disengaging the clutch 60. Referring to FIG. 2, the connections establishing the two power flow paths are shown.

When the clutch 60 is engaged, engine torque is transferable from a flywheel (not shown), through the torque converter cover 30, through the clutch 60, and to the driving member 66. The rotation of the driving member 66 is transferable through the damper spring 64 and to the driven member 68. The driven member 68 includes a splined portion 70 adapted to engage a complementary splined portion 72 of a carrier 74 such that the rotation of the driven member 68 is transferable to the carrier 74. The carrier 74 includes a second splined portion 76 adapted to engage a complementary splined portion 78 of the transmission input shaft 36 such that the rotation of the carrier 74 is transferable to the transmission input shaft 36. Accordingly, when the clutch 60 is engaged, the planetary gearset 14 and the torque converter 16 are bypassed and engine torque is transferable to the transmission without torque multiplication or speed reduction.

When the clutch 60 is disengaged, engine torque is transferable from a flywheel (not shown), through the torque converter cover 30, through the housing 28 and to the pump 22. Rotation of the pump 22 causes the working fluid (not shown) to spin the turbine 24. The turbine 24 is coupled to the ring gear 54 such that the turbine 24 and ring gear 54 rotate together.

Rotation of the pump 22 also causes the working fluid to spin the stator 26 and the outer race 40 mounted thereto. The outer race 40 is connected to the sun gear member 50 such that the outer race 40 and the sun gear member 50 rotate together. The stator 26 is preferably locked by the one way clutch assembly 42 until the torque converter 16 reaches a torque converter speed ratio of approximately 0.8. As will be described in detail hereinafter, the clutch 60 is preferably only disengaged to provide expanded ratio coverage in the low gear range such that the stator 26 and the sun gear member 50 are generally locked or grounded. The rotation of the ring gear 54 which is driven by the turbine 24 causes the pinion 52 engaged therewith to rotate. The pinion 52 rotation is transferable through a spindle 80 and to the carrier 74. The second splined portion 76 of the carrier 74 which is engaged with the complementary splined portion 78 of the transmission input shaft 36 allows the transmission of torque from the carrier 74 to the transmission input shaft 36.

Having described the apparatus of the present invention hereinabove, the preferred method of operation will hereinafter be described. As previously indicated, when the clutch 60 is engaged, the planetary gearset 14 is bypassed and the torque converter speed ratio becomes 1.0 such that the 6 speed ratios of the preferred transmission 18 (i.e., 3.52, 1.88, 1.40, 1.00, 0.76 and 0.64) are available. Additional speed ratios are obtainable by releasing the clutch 60 while in one of the 6 transmission speed ratios such that the planetary gearset speed ratio is applied as a multiplication factor.

According to the preferred embodiment, the speed ratio of the planetary gearset 14 is 1.42, however, alternate planetary gearset configurations may also be implemented. The preferred planetary gearset 14 having a speed ratio of 1.42 reduces speed and correspondingly increases torque.

When the transmission 18 (shown in FIG. 1) is in first gear and the clutch 60 is engaged, the planetary gearset 14 is bypassed and the gear speed ratio is therefore 3.52. By disengaging the clutch while the transmission 18 is in first gear, the preferred planetary gearset speed ratio of 1.42 is applied as a multiplication factor to the transmission's first gear speed ratio of 3.52 thereby providing a speed ratio of 5.0 (i.e., 3.52×1.42).

When the transmission 18 (shown in FIG. 1) is in second gear and the clutch 60 is engaged, the planetary gearset 14 is bypassed and the gear speed ratio is therefore 1.88. By disengaging the clutch 60 while the transmission 18 is in second gear, the preferred planetary gearset speed ratio of 1.42 is applied as a multiplication factor to the transmission's second gear speed ratio of 1.88 thereby providing a speed ratio of 2.66 (i.e., 1.88×1.42). Therefore, the present invention provides two additional speed ratios (5.0 and 2.66) for a total of eight different speed ratios (5.0, 3.52, 2.66, 1.88, 1.40, 1.00, 0.76 and 0.64) with the 6-speed transmission 18.

The two additional speed ratios (5.0 and 2.66) of the present invention provide expanded ratio coverage in the low gear range. This expanded ratio coverage improves vehicle performance, and the additional low gear range coverage is particularly advantageous, for example, to increase low speed acceleration or when traveling up a steep incline. The expanded ratio coverage may also allow the use of a higher speed axel (not shown) to improve highway fuel economy. The present invention therefore represents a relatively inexpensive addition to an existing transmission, and does not require the time and expense associated with developing an entirely new transmission.

The additional speed ratios obtainable by releasing the clutch 60 while the transmission 18 is in one of the remaining gears 3-6 are not appreciably different from the speed ratios already available through the transmission 18. Therefore, the clutch 60 is preferably not disengaged unless the transmission is in first or second gear. It should be appreciated, however, that alternate embodiments involving different planetary gearset configurations and/or transmission configurations may envision generating additional speed ratios by releasing the clutch while the transmission is in one of the gears 3-6.

While the best modes for carrying out the invention have been described in detail, those familiar with the art to which this invention relates will recognize various alternative designs and embodiments for practicing the invention within the scope of the appended claims.

1. An apparatus configured to expand the gear ratio coverage of an automatic transmission comprising:
a torque converter operatively connected to and driven by an engine;
a planetary gearset operatively connected to said torque converter and the automatic transmission wherein output from the torque converter is transferable through the planetary gearset to the automatic transmission such that additional speed ratios are obtainable; and
a clutch disposed between the engine and the automatic transmission, said clutch being configured to selectively couple the engine and the automatic transmission such that the planetary gearset and the torque converter are bypassed.

2. The apparatus of claim 1, further comprising a damper assembly disposed between the clutch and the automatic transmission, said damper assembly being configured to at least partially absorb any engine torque spikes before they are transferred to the automatic transmission and thereby provide smoother operation.

3. The apparatus of claim 2, wherein said torque converter includes a pump operatively connected to the engine; a turbine operatively connected to the planetary gearset; and a stator disposed between the pump and the turbine.

4. The apparatus of claim 3, further comprising a one-way clutch assembly operatively connected to the stator and to the planetary gearset.

5. The apparatus of claim 4, wherein said planetary gearset includes a sun gear member operatively connected to the one-way clutch assembly; a ring gear member operatively connected to the turbine; and a pinion gear member operatively connected to the transmission.

6. The apparatus of claim 5, further comprising a ground sleeve operatively connected to said one-way clutch assembly such that at lease a portion of said one-way clutch is grounded.

7. The apparatus of claim 6, wherein said one-way clutch is a one-way roller clutch.

8. An apparatus configured to expand the gear ratio coverage of an automatic transmission having a first plurality of predefined speed ratios, said apparatus comprising:
a torque converter operatively connected to and driven by an engine;
a planetary gearset operatively connected to said torque converter and the automatic transmission wherein output from the torque converter is transferable through the planetary gearset to the automatic transmission such that a second plurality of predefined speed ratios are obtainable;
a clutch disposed between the engine and the automatic transmission, said clutch being configured to selectively couple the engine and the automatic transmission such that the planetary gearset is bypassed and the first plurality of predefined speed ratios are obtainable; and
a damper assembly disposed between the clutch and the automatic transmission, said damper assembly being configured to at least partially absorb any engine torque spikes before they are transferred to the automatic transmission and thereby provide smoother operation.

9. The apparatus of claim 8, wherein said torque converter includes a pump operatively connected to the engine; a turbine operatively connected to the planetary gearset; and a stator disposed between the pump and the turbine.

10. The apparatus of claim 9, further comprising a one-way clutch assembly operatively connected to the stator and to the planetary gearset.

11. The apparatus of claim 10, wherein said planetary gearset includes a sun gear member operatively connected to the one-way clutch assembly; a ring gear member operatively connected to the turbine; and a pinion gear member operatively connected to the transmission.

12. The apparatus of claim 11, further comprising a ground sleeve operatively connected to said one-way clutch assembly such that at lease a portion of said one-way clutch is grounded.

13. The apparatus of claim 12, wherein said one-way clutch is a one-way roller clutch.

14. An apparatus configured to expand the gear ratio coverage of an automatic transmission having a first plurality of predefined speed ratios, said apparatus comprising:
a torque converter operatively connected to and driven by an engine, said torque converter including a pump operatively connected to the engine; a turbine operatively connected to the planetary gearset; and a stator disposed between the pump and the turbine;
a planetary gearset including:
a ring gear member operatively connected to the turbine of the torque converter;
a sun gear member operatively connected to the stator of the torque converter; and
a pinion gear member operatively connected to the automatic transmission;
wherein output from the turbine of the torque converter is transferable through the planetary gearset to the automatic transmission such that a second plurality of predefined speed ratios are obtainable;
a clutch disposed between the engine and the automatic transmission, said clutch being configured to selectively couple the engine and the automatic transmission such that the planetary gearset is bypassed and the first plurality of predefined speed ratios are obtainable; and
a damper assembly disposed between the clutch and the automatic transmission, said damper assembly being configured to at least partially absorb any engine torque spikes before they are transferred to the automatic transmission and thereby provide smoother operation.

15. The apparatus of claim 14, further comprising a one-way clutch assembly operatively connected to the stator and to the planetary gearset.

16. The apparatus of claim 15, further comprising a ground sleeve operatively connected to said one-way clutch assembly such that at lease a portion of said one-way clutch is grounded.

17. The apparatus of claim 16, wherein said one-way clutch is a one-way roller clutch.
